(19) United States
(12) Patent Application Publication
(10) Pub. No.: US 2026/0260505 A1
(43) Pub. Date: Sep. 3, 2026

(54) ELECTRONIC DEVICE FOR STORING BOTH SUMMARY OF VIDEO AND CAPTURED IMAGE OF VIDEO AND OPERATION METHOD THEREOF

(71) Applicant: SAMSUNG ELECTRONICS CO., LTD., Suwon-si (KR)

(72) Inventors: Munhwi KIM, Suwon-si (KR); Dongil SON, Suwon-si (KR)

(21) Appl. No.: 19/650,647

(22) Filed: Apr. 17, 2026

Related U.S. Application Data
(63) Continuation of application No. PCT/KR2024/011594, filed on Aug. 6, 2024.

(30) Foreign Application Priority Data
Oct. 25, 2023 (KR) 10-2023-0143791
Nov. 8, 2023 (KR) 10-2023-0153826

(51) Int. Cl. G06V 20/70; G06V 20/40

(52) U.S. Cl. CPC G06V 20/70; G06V 20/47

(57) ABSTRACT

Disclosed are an electronic device for storing both summary of video and captured image of video and operation method. An electronic device according to an example embodiment may include a memory for storing instructions and a processor for executing the instructions. The instructions, when executed by the processor, may cause the electronic device to, determine whether a display of the electronic device is outputting a video when the electronic device receives a capture command from a user, generate summary data summarizing content of the video when the display is outputting the video, and store a captured image obtained at least by capturing a screen being output by the display and the summary data in the memory.

### CROSS-REFERENCE TO RELATED APPLICATIONS

This application is a continuation application of International Application No. PCT/KR2024/011594, filed on Aug. 6, 2024, in the Korean Intellectual Property Receiving Office, and claiming priority to KR Application No. 10-2023-0143791 filed Oct. 25, 2023 and KR Application No. 10-2023-0153826 filed Nov. 8, 2023, the disclosures of which are all hereby incorporated by reference herein in their entireties.

### TECHNICAL FIELD

An electronic device, in certain example embodiments, for storing a summary of a video together with a captured image of the video, and/or an operating method thereof.

### BACKGROUND

With the development of technology, an electronic device, such as a smartphone, has become essential in everyday life. Users may access the Internet through an electronic device and access a vast amount of information through the Internet. Since it is impossible to remember a vast amount of information after seeing it just once, users may store the necessary information in an electronic device through screen capture, which stores a screen being output by a display of the electronic device.

With the recent development of technology, users may access a vast amount of information not only through text but also through videos. Accordingly, users may capture a predetermined image of a video including desired information and store the captured image in an electronic device.

### SUMMARY

An electronic device according to an example embodiment may include memory storing instructions. The electronic device may include a processor (including one or more processors), comprising processing circuitry, for executing the instructions. The instructions, when executed individually and/or collectively by the processor, may cause the electronic device to determine whether a display of the electronic device is outputting a video when the electronic device receives a capture command from a user. The instructions, when executed individually and/or collectively by the processor, may cause the electronic device to generate summary data summarizing content of the video when the display is outputting the video. The instructions, when executed individually and/or collectively by the processor, may cause the electronic device to store a captured image obtained by capturing a screen being output by the display and the summary data together in the memory. The instructions, when executed individually and/or collectively by the processor, may cause the electronic device to display the captured image and the summary data together on the display.

An electronic device according to an example embodiment may include memory storing instructions. The electronic device may include a processor (including one or more processors), comprising processing circuitry, for executing the instructions. The instructions, when executed individually and/or collectively by the processor, may cause the electronic device to determine whether a display of the electronic device is outputting a video when the electronic device receives a capture command from a user. The instructions, when executed individually and/or collectively by the processor, may cause the electronic device to generate summary data summarizing content of the video when the display is outputting the video. The instructions, when executed individually and/or collectively by the processor, may cause the electronic device to store a captured image obtained by capturing a screen being output by the display and the summary data together in the memory. The summary data may summarize the content of the video based on the capture command.

An operating method of an electronic device according to an example embodiment may include determining whether a display of the electronic device is outputting a video when the electronic device receives a capture command from a user. The operating method of the electronic device may include generating summary data summarizing content of the video when the display is outputting the video. The operating method of the electronic device may include storing a captured image obtained by capturing a screen being output by the display and the summary data together in memory. The operating method of the electronic device may include displaying the captured image and the summary data together on the display.

A computer-readable storage medium according to an example embodiment may store a program for executing the operating method of the electronic device described above.

An operating method of an electronic device according to an example embodiment may include determining whether a display of the electronic device is outputting a video when the electronic device receives a capture command from a user. The operating method of the electronic device may include generating summary data summarizing content of the video when the display is outputting the video. The operating method of the electronic device may include storing a captured image obtained by capturing a screen being output by the display and the summary data together in memory. The summary data may summarize the content of the video based on the capture command.

A computer-readable storage medium according to an example embodiment may store a program for executing the operating method of the electronic device described above.

### BRIEF DESCRIPTION OF DRAWINGS

FIG. 1 is a block diagram illustrating an electronic device in a network environment, according to various example embodiments.

FIG. 2 is a block diagram of an electronic device according to an example embodiment.

FIG. 3 is a block diagram of generating summary data of a video, according to an example embodiment.

FIG. 4 is a flowchart of generating summary data of a video, according to an example embodiment.

FIG. 5 is a diagram illustrating the generation of summary data according to a first capture command, according to an example embodiment.

FIG. 6 is a diagram illustrating the generation of summary data according to a second capture command, according to an example embodiment.

FIG. 7 is a diagram illustrating the display of a captured image and summary data, according to an example embodiment.

FIG. 8 is a diagram illustrating the generation of summary data of a web page, according to an example embodiment.

FIG. 9 is a diagram illustrating an operating method of an electronic device, according to an example embodiment.

### DETAILED DESCRIPTION

Hereinafter, the embodiments will be described in detail with reference to the accompanying drawings. When describing the embodiments with reference to the accompanying drawings, like reference numerals refer to like components, and any repeated description related thereto will be omitted.

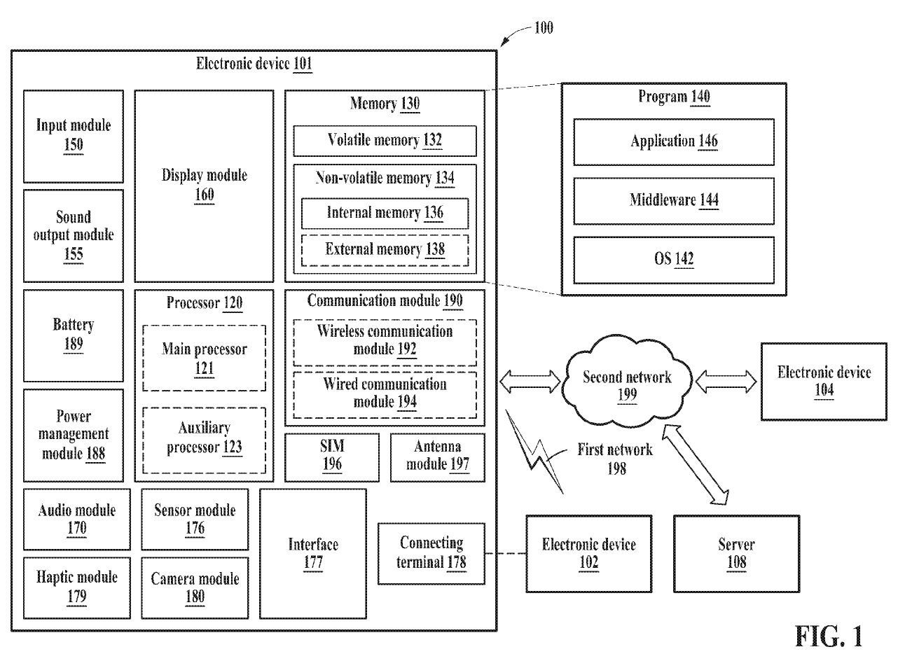

FIG. 1 is a block diagram illustrating an electronic device 101 in a network environment 100, according to various embodiments. Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added to the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled, directly or indirectly, with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an ISP or a CP) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), a deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150 or output the sound via the sound output module 155 or an external electronic device (e.g., the electronic device 102) (e.g., a speaker or headphone) directly or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

The connecting terminal 178 may include a connector via which the electronic device 101 may be physically connected, directly or indirectly, with the external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, ISPs, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more CPs that are operable independently from the processor 120 (e.g., the AP) and support a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via the first network 198 (e.g., a short-range communication network, such as Bluetooth^{TM}, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multiple components (e.g., multiple chips) separate from each other. The wireless communication module 192 may identify and authenticate the electronic device 101 in a communication network, such as the first network 198 or the second network 199, using subscriber information (e.g., international mobile subscriber identity (IMSI)) stored in the SIM 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a PCB, a RFIC disposed on a first surface (e.g., the bottom surface) of the PCB, or adjacent to the first surface and capable of supporting a designated high-frequency band (e.g., the mmWave band), and a plurality of antennas (e.g., array antennas) disposed on a second surface (e.g., the top or a side surface) of the PCB, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an Internet-of-Things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as "A or B," "at least one of A and B," "at least one of A or B," "A, B, or C," "at least one of A, B, and C," and "at least one of A, B, or C," may include any one of, or all possible combinations of the items enumerated together in a corresponding one of the phrases. As used herein, such terms as "1st" and "2nd," or "first" and "second" may be used to simply distinguish a corresponding component from another, and does not limit the components in other aspect (e.g., importance or order). It is to be understood that if an element (e.g., a first element) is referred to, with or without the term "operatively" or "communicatively", as "coupled with," "coupled to," "connected with," or "connected to" another element (e.g., a second element), it means that the element may be coupled with the other element directly (e.g., wiredly), wirelessly, or via at least a third element(s).

As used in connection with various embodiments of the disclosure, the term "module" may include a unit implemented in hardware, software, or firmware, and may interchangeably be used with other terms, for example, "logic," "logic block," "part," or "circuitry". A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it. This allows the machine to be operated to perform at least one function according to the at least one instruction invoked. The one or more instructions may include code generated by a complier or code executable by an interpreter. The machine-readable storage medium may be provided in the form of a non-transitory storage medium. Wherein, the term "non-transitory" simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore^{TM}), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

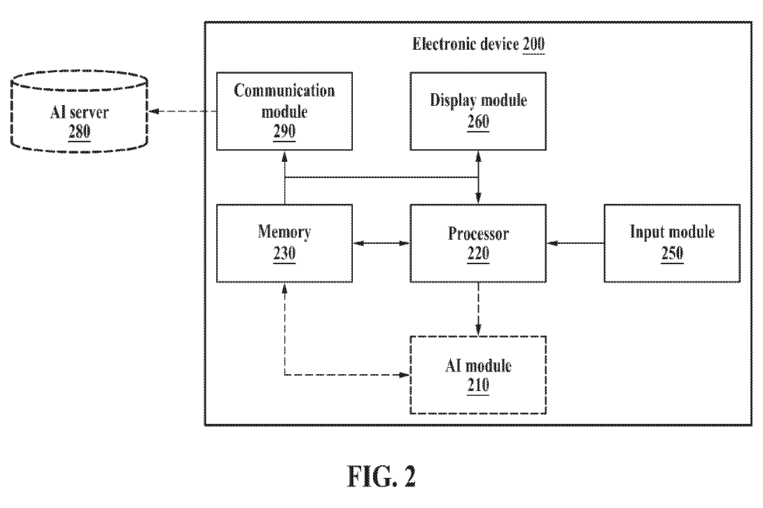

FIG. 2 is a block diagram of an electronic device according to an example embodiment.

FIG. 2 illustrates an electronic device 200 (e.g., the electronic device 101 of FIG. 1) for generating summary data of a video. In the example of FIG. 2, only the components related to the embodiments described herein are illustrated as being included in the electronic device 200. Thus, the electronic device 200 may also include other general-purpose components in addition to the components illustrated in FIG. 2.

A processor 220 (e.g., the processor 120 of FIG. 1) may execute instructions stored in memory 230 (e.g., the memory 130 of FIG. 1). The instructions, when executed by the processor 220, may cause the electronic device 200 to perform the following operations.

The processor 220 may receive a capture command from a user through an input module 250 (e.g., the input module 250 of FIG. 1). When the capture command is received, the processor 220 may determine whether a display module 260 (e.g., the display module 160 of FIG. 1) is outputting a video.

The processor 220 may generate the summary data of the video when the display module 260 is outputting the video. According to an embodiment, the electronic device 200 may include an artificial intelligence (AI) module 210 and may generate the summary data of the video using the AI module 210. The AI module 210 may generate the summary data of the video using various AI models. For example, the AI module 210 may generate the summary data of the video using AI models, such as a large language model (LLM), a scene analysis model, and generative AI.

According to an embodiment, the summary data of the video may be generated through one or more AI models. The video may include pieces of data, such as sound data, subtitle data, image sequence data, and description data. These pieces of data may be input to one or more AI models. The summary data of the video may be generated based on the outputs of one or more AI models. That is, the sound data, subtitle data, image sequence data, and description data may be input to one AI model, thereby generating the summary data of the video. Additionally, a combination including one or more of the sound data, subtitle data, image sequence data, and description data may be input to one or more AI models, thereby generating the summary data of the video.

According to an embodiment, the AI module 210 may assign a weight to each piece of data included in the video, based on the type of video. The AI module 210 may generate the summary data based on the pieces of weighted data. That is, the AI module 210 may generate the summary data based on pieces of data to which high weights are assigned. For example, when the video is a landscape video, the AI module 210 may set a weight of the image sequence data to be higher than weights of other pieces of data. Accordingly, the summary data of the landscape video may be generated based on the image sequence data. For example, when the video is a discussion video, the AI module 210 may set a weight of the sound data to be higher than weights of other pieces of data. Accordingly, the summary data of the discussion video may be generated based on the sound data.

According to an embodiment, the electronic device 200 may communicate with an AI server 280 through a communication module 290 (e.g., the communication module 190 of FIG. 1). The AI server 280 may generate summary information of the video and transmit the summary information to the electronic device 200. The AI server 280 may generate the summary data of the video using various AI models. The AI server 280 generates the summary data of the video outside the electronic device 200, but its role may be the same as that of the AI module 210. Accordingly, the description of the AI module 210 may be equally applied to the AI server 280.

According to an embodiment, the AI server 280 or the AI module 210 may receive, as an input, information about the video and a playback position of the video corresponding to a capture time point. According to an embodiment, when the video is being played in an application (e.g., the application 146 of FIG. 1) that provides streaming, the AI server 280 or the AI module 210 may receive, as an input, a link and the playback position of the video corresponding to the capture time point.

When generating the summary data, information about the playback position may be used to determine a section of the video for generating the summary data.

The memory 230 may store a captured image together with the summary data. The memory 230 may store the summary data together as additional information of the captured image. The summary data stored together may also be loaded when the captured image is loaded from the memory 230 to display the captured image on the display module 260.

Hereinafter, a flow in which the summary data of the video is generated is further described.

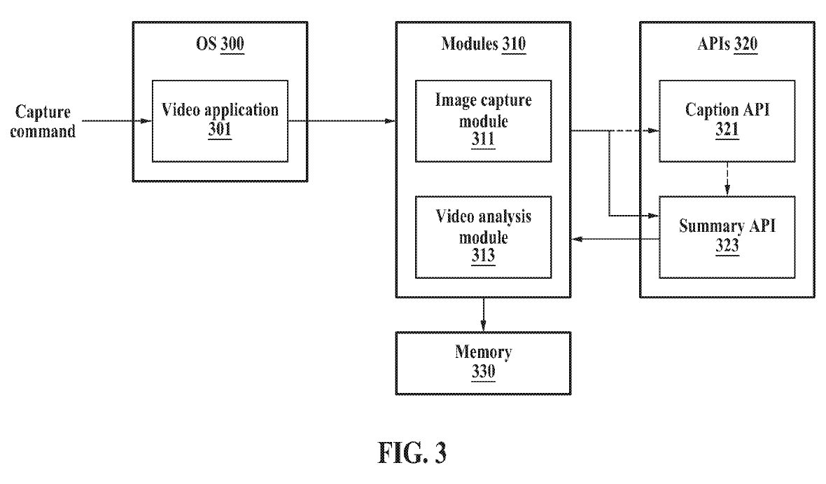

FIG. 3 is a block diagram of generating summary data of a video, according to an example embodiment.

When a capture command to capture a screen being output by a display module is received from a user, a processor (e.g., the processor 120 of FIG. 1 and the processor 220 of FIG. 2) may determine whether a video application 301 (e.g., the application 146 of FIG. 1) of an OS 300 (e.g., the OS 142 of FIG. 1) is executing a video. According to an embodiment, the video application 301 may be a media player provided by the OS 300. According to an embodiment, the video application 301 may be an application that provides a video streaming service.

According to an embodiment, when the video application 301 is a media player provided by the OS 300 and the video application 301 is executing the video, the OS 300 may transmit, to modules 310, the video and a playback position of the video corresponding to the time point at which the capture command is generated. According to an embodiment, when the video application 301 is an application that provides a video streaming service and the video application 301 is executing the video, a link to the video may be transmitted to the modules 310.

The modules 310 may perform capture and analyze the video. The modules 310 may include an image capture module 311 that performs capture and a video analysis module 313 that analyzes videos. Referring to FIG. 3, the modules 310 may include the image capture module 311 and the video analysis module 313. However, the present disclosure is not limited thereto, and it is obvious to those skilled in the art that the modules 310 may further include other modules necessary for generating the summary data of the video. According to an embodiment, the video analysis module 313 may be included in an AI module (e.g., the AI module 210 of FIG. 2).

The video analysis module 313 may analyze a video and output video analysis data of the video. According to an embodiment, the video analysis module 313 may be a single module that does not include sub-modules.

According to an embodiment, the video analysis module 313 may include a plurality of sub-modules. The video analysis module 313 may include sub-modules that analyze one or more pieces of data included in the video. For example, when the video application 301 is an application that provides a video streaming service and the modules 310 receive a link to the video, the link may include subtitle data of the video. Accordingly, the video analysis module 313 may further include a sub-module that analyzes the subtitle data.

According to an embodiment, the video may not provide subtitle data, or the link to the video may not provide subtitle data of the video. In this case, the video analysis module 313 may extract the subtitle from the video. In addition, the AI module (e.g., the AI module 210 of FIG. 2) inside an electronic device (e.g., the electronic device 101 of FIG. 1 and the electronic device 200 of FIG. 2) and/or the AI server 280 outside the electronic device may extract the subtitle from the video and/or the link to the video.

According to an embodiment, when the video application 301 is capable of parsing the video, the video application 301 may analyze the video. In this case, the modules 310 may not perform separate analysis but only transmit the data analyzed by the video application 301 to application programming interfaces (APIs) 320.

According to an embodiment, the video analysis data output from the video analysis module 313 may include pieces of analysis data for each piece of data (e.g., sound data, subtitle data, image sequence data, description data, and the like) included in the video. According to an embodiment, the video analysis data may be data that aggregates the pieces of analysis data for each piece of data included in the video.

The modules 310 may transmit the video analysis data to the APIs 320. According to an embodiment, the APIs 320 may be included in the AI module. The APIs 320 may generate the summary data of the video using the video analysis data. The APIs 320 may include a summary API 323 summarizing the video analysis data.

According to an embodiment, when the summary API 323 requires further interpretation of the video analysis data to generate summary data, the APIs 320 may further include a caption API 321. FIG. 3 illustrates the caption API 321 and the summary API 323, but the present disclosure is not limited thereto, and it is obvious to those skilled in the art that APIs necessary for generating the summary data of the video may be further included.

The summary data may include one or more of a summary of the entire video, a summary of a captured image, and summaries of predetermined sections. That is, the summary data may include data summarizing content included in the entire video, regardless of the time point at which the capture command is generated. The summary data may include data summarizing content related to the captured image. The summary data may include data summarizing content included in a section from the beginning of the video to the playback position of the video corresponding to the time point at which the capture command is generated. The summary data may include data summarizing content included in a section from the playback position of the video corresponding to the time point at which the capture command is generated to the end of the video. The summary data may include data summarizing content included in a section controlled according to the operation of the user, based on the time point at which the capture command is generated.

The APIs 320 may transmit the summary data to the modules 310. The modules 310 may store the summary data of the video and the captured image together in memory 330. According to an embodiment, one or more operations performed by the APIs 320 may be performed by the AI module inside the electronic device. Alternatively, one or more operations performed by the APIs 320 may be performed by an AI server outside the electronic device.

Hereinafter, an operation in which the electronic device generates the summary data of the video and stores the summary data together with the captured image is described.

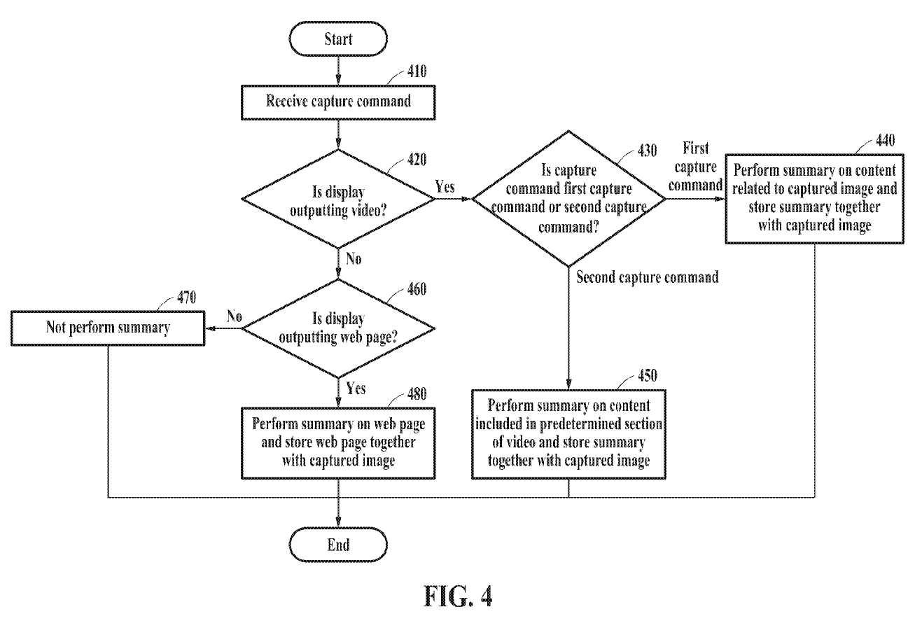

FIG. 4 is a flowchart of generating summary data of a video, according to an example embodiment.

The operations described below may be performed sequentially but not necessarily. For example, the order of the operations may be changed, and at least two operations may be performed in parallel. The operations illustrated in FIG. 4 may be performed by at least one component of an electronic device (e.g., the electronic device 101 of FIG. 1 and the electronic device 200 of FIG. 2).

In operation 410, the electronic device may receive a capture command from a user.

In operation 420, the electronic device may determine whether a display (e.g., the display module 160 of FIG. 1 and the display module 260 of FIG. 2) is outputting a video.

According to an embodiment, when a display module is outputting a video, the electronic device may further determine whether the video is being played. When the video is not being played, the electronic device may simply capture a screen being output by the display module and store the screen as a captured image. When the video is being played, the electronic device may capture the screen being output by the display module and store the screen as the captured image as well as store summary data of the video. When the video is being played, the electronic device may perform operation 430 of storing the summary data of the video together with the captured image. According to an embodiment, the electronic device may store the captured image and the summary data together even when the video is not being played. Here, it is obvious to those skilled in the art that the method of storing the captured image and the summary data together when the video is being played may be equally applied to the method of storing the captured image and the summary data together when the video is not being played.

In operation 430, when the display module is outputting the video, the electronic device may determine whether the capture command is a first capture command or a second capture command.

The first capture command and the second capture command may be determined according to the time when the capture command is generated. When the capture command is generated for a time that is less than a threshold time, the capture command may be determined to be the first capture command. For example, when the user momentarily presses a combination of one or more input buttons defined as capture commands, the capture command may be determined to be the first capture command. When the capture command is generated for a time that is greater than or equal to the threshold time, the capture command may be determined to be the second capture command. For example, when the user presses a combination of one or more input buttons defined as capture commands for a time that is greater than or equal to the threshold time, the capture command may be determined to be the second capture command.

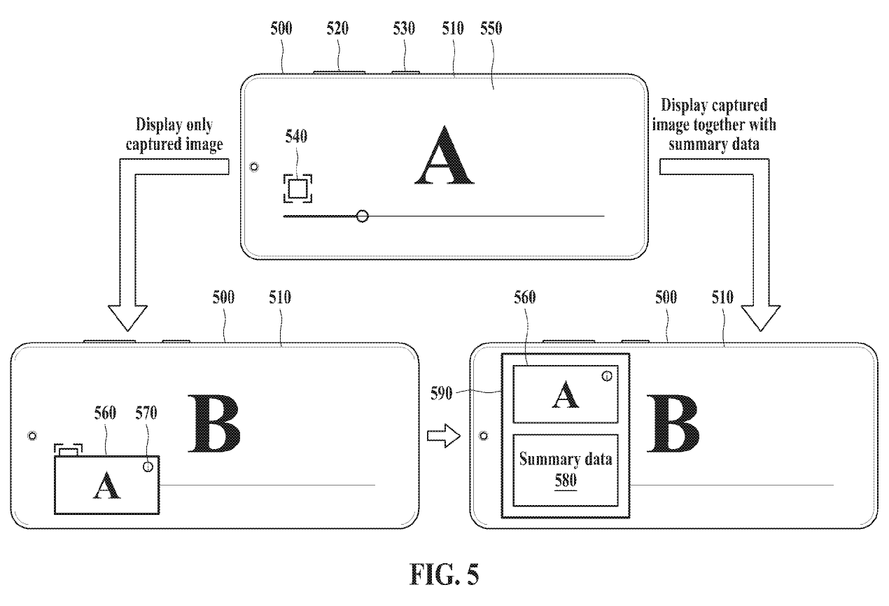

In operation 440, when the capture command is determined to be the first capture command, the electronic device may perform a summary on content related to the captured image and store the summary together with the captured image. A method of storing the captured image by the first capture command and the summary data related to the captured image together is described below with reference to FIG. 5.

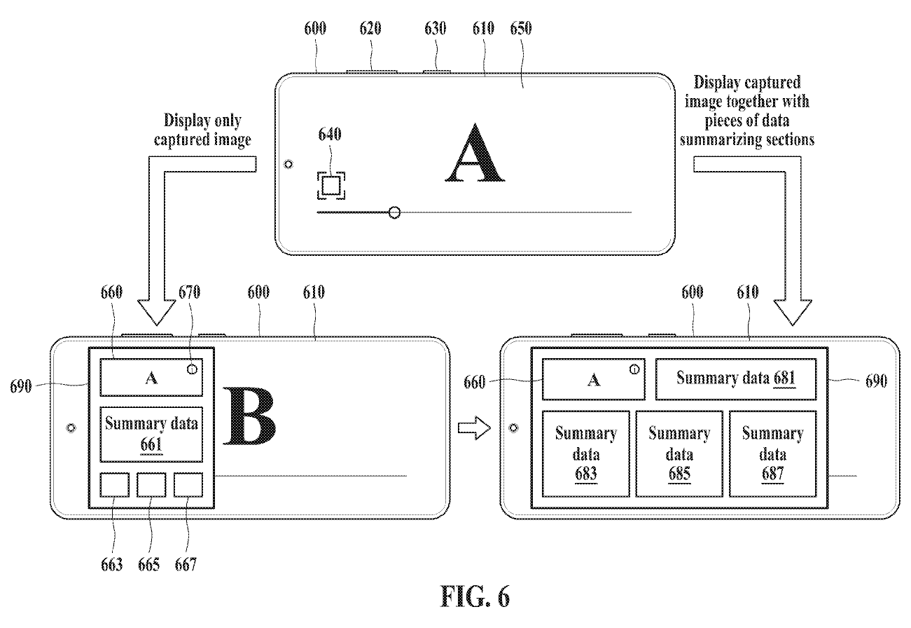

In operation 450, when the capture command is determined to be the second capture command, the electronic device may perform a summary on content included in a predetermined section of the video and store the summary together with the captured image. A method of storing the captured image by the second capture command and the summary data summarizing the content included in the predetermined section of the video is described below with reference to FIG. 6.

In operation 460, when the display is not outputting the video, the electronic device may determine whether the display is outputting a web page.

In operation 470, when the display is not outputting the web page, the electronic device may not perform a summary on the captured image. That is, the summary data may not be generated and only the captured image may be stored.

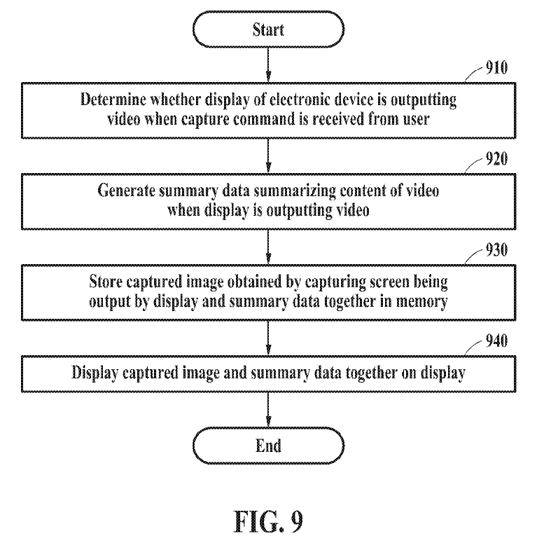

In operation 480, when the display is outputting the web page, the electronic device may perform a summary on the web page and store the web page together with the captured image. A method of generating the summary data of the web page is described below with reference to FIG. 9.

Hereinafter, a method of generating the summary data according to the first capture command and displaying the summary data on the display when the display is outputting a video is described.

FIG. 5 is a diagram illustrating the generation of summary data according to a first capture command, according to an example embodiment.

FIG. 5 illustrates an electronic device 500 (e.g., the electronic device 101 of FIG. 1 and the electronic device 200 of FIG. 2) playing a video.

The electronic device 500 may receive a capture command while outputting the video to a display 510 (e.g., the display module 160 of FIG. 1 and the display module 260 of FIG. 2).

According to an embodiment, the capture command may be defined as a combination of one or more of a plurality of input buttons included in the electronic device 500. For example, the electronic device 500 may include volume control buttons 520 and a power button 530, and the capture command may be generated by a combination of a volume down button among the volume control buttons and the power button 530. Alternatively, according to an embodiment, the capture command may be generated by touching a capture object 540 displayed on the display 510, rather than a physical button. However, the capture command is not limited to the examples described above, and it is obvious to those skilled in the art that the capture command may be generated by various methods.

According to an embodiment, the capture command may be generated based on a system capture input that is a global capture input. That is, the electronic device 500 may perform storage of a captured image and summary data 580 on both a capture command generated by a hardware capture input and a capture command generated by a software capture input provided as a function by an application, such as a video player. In addition, the electronic device 500 may perform storage of a captured image and summary data 580 on third-party applications, in addition to applications provided by the manufacturer of the electronic device 500. According to an embodiment, even when a capture input is performed in an application, the electronic device 500 may operate as a system capture input and store the summary data 580 together with the captured image.

The first capture command may be obtained by generating the capture command for a time that is less than a threshold time. For example, when the volume down button among the volume control buttons 520 and the power button 530 are pressed for a time that is less than the threshold time, the generated capture command may be determined to be the first capture command. For example, when the capture object 540 is touched for a time that is less than the threshold time, the generated capture command may be determined to be the first capture command.

When the first capture command is received, in the electronic device 500, a frame image 550 of the video corresponding to the time point at which the capture command is generated may be captured, and summary data 580 of the frame image 550 may be generated.

Hereinafter, a case in which only a captured image 560 is displayed or a case in which the captured image 560 and summary data 580 of the captured image 560 are displayed together is described. Whether the captured image 560 and the summary data 580 are displayed together may vary depending on the user's preset settings.

According to an embodiment, the captured image 560 may be briefly displayed as a preview in a predetermined area of the display 510. That is, the captured image 560 may be displayed in a pop-up format. The predetermined area may be the lower left area of the display. However, this is merely an example and the present disclosure is not limited thereto. When the captured image 560 is displayed as a preview, an indicator 570 indicating that the summary data 580 of the captured image 560 is stored together may be displayed together. That is, although the summary data 580 is generated, the summary 580 data may not be displayed on the display 510, and only the indicator 570 indicating that the summary data 580 is generated may be displayed on one side of the captured image 560. In addition, since the display 510 is outputting the video being played, the display 510 may display a frame image that is different from the captured image 560 in the video playback area. According to an embodiment, when the indicator 570 is touched (e.g., selected), the captured image 560 and the summary data 580 may be displayed together.

According to an embodiment, the captured image 560 and the summary data 580 of the captured image 560 may be displayed together on an interface 590 generated in a predetermined area of the display 510. The interface 590 displaying the captured image 560 in a preview format may be displayed in a predetermined area, before the captured image 560 is stored together with the summary data 580. The interface 590 may be displayed on the display 510 in a pop-up format. The predetermined area may be an area biased to the left of the display 510. However, this is merely an example and the present disclosure is not limited thereto. The summary data 580 may be data summarizing content related to the captured image 560. Accordingly, the summary data 580 may include content that is not included in the captured image 560. That is, the summary data 580 may further include content of the captured image 560 included in the video but not included in the captured image 560, in addition to content included in the captured image 560. To this end, to accurately perform a summary on the captured image 560, the electronic device 500 may analyze the preceding and following videos based on the playback position of the video corresponding to the time point at which the capture command is generated. In addition, the electronic device may include data summarizing the analysis of the preceding and following videos in the summary data 580.

For example, it may be assumed that the video is a lecture video that presents English sentences numbered 1 to 6. The first capture command may be generated while the description of sentence 3 is being output to the display 510. The electronic device 500 may include, in the summary data 580, a summary of the description of sentence 3 included in the preceding and following videos based on the playback position of the video corresponding to the time point at which the captured image 560 is generated, in addition to a summary of the description of sentence 3 included in the captured image 560.

Hereinafter, a method of generating summary data according to a second capture command and displaying the summary data on the display when the display is outputting a video is described.

FIG. 6 is a diagram illustrating the generation of summary data according to a second capture command, according to an example embodiment.

FIG. 6 illustrates an electronic device 600 (e.g., the electronic device 101 of FIG. 1, the electronic device 200 of FIG. 2, and the electronic device 500 of FIG. 5) playing a video.

The electronic device 600 may receive a capture command while outputting the video to a display 610 (e.g., the display module 160 of FIG. 1, the display module 260 of FIG. 2, and the display module 510 of FIG. 5).

The general description of the capture command is described above with reference to FIG. 5, so a repeated description thereof is omitted. The second capture command may be obtained by generating the capture command for a time that is greater than or equal to a threshold time. For example, when a volume down button among volume control buttons 620 (e.g., the volume control buttons 520 of FIG. 5) and a power button 630 (e.g., the power button 530 of FIG. 5) are pressed for a time that is greater than or equal to the threshold time, the generated capture command may be determined to be the second capture command. For example, when a capture object 640 (e.g., the capture object 540 of FIG. 5) is touched for a time that is greater than or equal to the threshold time, the generated capture command may be determined to be the second capture command. According to an embodiment, the second capture command may be a command to generate summary data of content of the video played while the capture command is generated from the time point at which the capture command is generated. For example, while the video is being played, the second capture command may be generated at 1 minute of the playback time point of the video and up to 1 minute and 30 seconds of the playback time point of the video. Here, the second capture command may be a command to generate summary data summarizing content from 1 minute to 1 minute and 30 seconds in the playback section of the video.

When the second capture command is received, in the electronic device 600, a frame image 650 (e.g., the frame image 550 of FIG. 5) of the video corresponding to the time point at which the capture command is generated may be captured, and summary data based on the time point at which the capture command is generated may be generated.

Hereinafter, a case in which the summary data (e.g., the summary data summarizing content included in a predetermined section of the video) generated based on the time point at which the capture command is generated is not displayed together with a captured image 660 or a case in which the summary data is displayed together with the captured image 660 is described. Whether the captured image 660 and the pieces of data summarizing the section are displayed together may vary depending on the user's preset settings.

According to an embodiment, the captured image 660 and the summary data may be displayed together on an interface 690 (e.g., the interface 590 of FIG. 5) generated in a predetermined area of the display 610. The interface 690 may display an interface displaying the captured image 660 in a preview format before the captured image 660 is stored together with the summary data. For example, the interface 690 may display the captured image 660 together with summary data 661 in a preview format before the captured image 660 is stored. For example, the interface 690 may display an interface displaying the captured image 660 together with summary data 683, summary data 685, and summary data 687 in a preview format before the captured image 660 is stored. The interface 690 may be displayed on the display 610 in a pop-up format. The predetermined area may be an area biased to the left of the display 610. However, this is merely an example and the present disclosure is not limited thereto. When the captured image 660 is displayed as a preview, the summary data 661 may be displayed together in the lower area. According to an embodiment, the summary data 661 displayed together with the captured image 660 may be summary data of the entire video. Alternatively, according to an embodiment, the summary data 661 (e.g., the summary data 580 of FIG. 5) displayed together with the captured image 660 may be summary data of the captured image 660. That is, the summary data 661 may be data summarizing only the content included in the captured image 660.

A plurality of buttons 663, 665, and 667 may be disposed in the lower area of the summary data 661. The button 663 may be a button that generates a command to store summary data summarizing content included in a section from the beginning of the video to a playback position of the video corresponding to the time point at which the capture command is generated, together with the captured image 660. The button 665 may be a button that generates a command to store summary data summarizing content included in a section from the playback position of the video corresponding to the time point at which the capture command is generated to the end of the video, together with the captured image 660. The button 667 may be a button that generates a command to store summary data summarizing content included in a section controlled according to the operation of a user, based on the time point at which the capture command is generated, together with the captured image 660. When the button 667 is selected, an interface for receiving, from the user, a section of the video in which the summary data is generated may be displayed. The positions of the captured image 660, the summary data 661, and the plurality of buttons 663, 665, and 667 disposed in the display 610 in FIG. 6 are merely examples and are not limited thereto. According to an embodiment, an indicator 670 (e.g., the indicator 570 of FIG. 5) indicating that the summary data of the captured image 660 is stored together with the captured image 660 may be displayed together. According to an embodiment, when the indicator 670 is touched, the pieces of summary data 683, 685, and 687 generated based on the time point at which the capture command is generated may be further displayed.

According to an embodiment, the interface 690 of the display 610 may display the pieces of summary data 683, 685, and 687 generated based on the time point at which the capture command is generated, together with the captured image 660. The interface 690 may be displayed on the display 610 in a pop-up format. The predetermined area may be biased to the left of the display 610. However, this is merely an example and the present disclosure is not limited thereto. According to an embodiment, when the captured image 660 is displayed as a preview, summary data 681 may be displayed together in the left area. According to an embodiment, the summary data 681 displayed together with the captured image 660 may be summary data of the entire video. Alternatively, according to an embodiment, the summary data 681 displayed together with the captured image 660 may be summary data of the captured image 660. That is, the summary data 681 may be data summarizing only the content included in the captured image 660.

Pieces of summary data summarizing a different section may be displayed in the lower area of the captured image 660 and the summary data 681.

The summary data 683 may be summary data summarizing content included in a section from the beginning of the video to the playback position of the video corresponding to the time point at which the capture command is generated.

The summary data 685 may be summary data summarizing content included in a section from the playback position of the video corresponding to the time point at which the capture command is generated to the end of the video.

The summary data 687 may be summary data summarizing content included in a section controlled according to the operation of the user, based on the time point at which the capture command is generated. According to an embodiment, the section controlled according to the operation of the user may be preset before the capture command is generated. For example, when the second capture command is generated, the summary data 687 may be preset to summarize content included in a section corresponding to 5 minutes before and after the capture command is generated, that is, a total of 10 minutes.

Although not illustrated in FIG. 6, a button that generates a command to store the summary data together with the captured image 660 may be disposed at the lower end of each of the pieces of summary data 683, 685, and 687. In addition, although not illustrated in FIG. 6, a button that cancels a capture may be disposed at the lower end of each of the pieces of summary data 683, 685, and 687. According to an embodiment, an edit button may be further disposed at the lower end of the summary data 685. When the edit button is selected, an interface that changes the section in which the summary data is generated or receives a topic for generating the summary data may be further displayed on the display 610. That is, the electronic device may receive, from the user, the section in which the summary data is generated through the edit button. The electronic device may regenerate the summary data of the section that is input from the user and store the summary data together with the captured image 660. The electronic device may receive the topic for generating the summary data from the user through the edit button. For example, when the video provides a description of English sentences and a predetermined English word is received from the user through the edit button, the electronic device may generate summary data focusing on the predetermined English word. It is obvious to those skilled in the art that the section and topic may be input by various methods other than the method described above.

Hereinafter, for ease of description, it may be assumed that the video sequentially describes English sentences numbered 1 to 6. In addition, it may be assumed that the second capture command is received while the display 610 is outputting content describing English sentence 3 of the video. Here, when the second capture command is received, the electronic device may automatically generate summary data summarizing the description of English sentences 1 to 3 (e.g., a previous section of the time point at which capture occurs) based on a section describing English sentence 3 of the video. When the second capture command is received, the electronic device may automatically generate summary data summarizing the description of English sentences 3 to 6 based on the section describing English sentence 3 of the video. When the second capture command is received, the electronic device may automatically generate summary data summarizing a section according to the user's setting based on the section describing English sentence 3 of the video. Here, the summary data 683 may be data summarizing the description of English sentences 1 to 3. The summary data 685 may be data summarizing the description of English sentences 3 to 6. The summary data 687, which is summary data summarizing the content included in the section controlled according to the operation of the user, based on the time point at which the capture command is generated, may include the description of English sentences 2 to 5 when the section controlled according to the operation of the user includes the description of English sentences 2 to 5. According to an embodiment, the electronic device may receive a section in which the summary data is generated from the user through the edit button. That is, even when the pieces of summary data are generated, the electronic device may receive the section in which the summary data is generated from the user through the edit button. The summary data summarizing the description of English sentences 1 to 4 may be regenerated in the section that is input by the user through the edit button.

Hereinafter, a method of displaying the summary data and the captured image, which are stored together, is described.

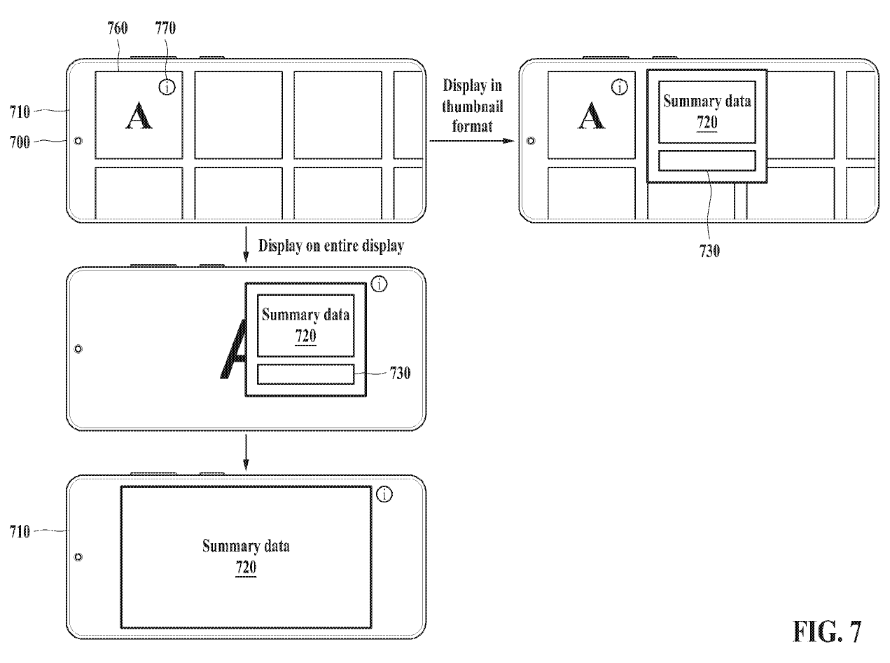

FIG. 7 is a diagram illustrating the display of a captured image and summary data, according to an example embodiment.

FIG. 7 illustrates an electronic device 700 (e.g., the electronic device 101 of FIG. 1, the electronic device 200 of FIG. 2, the electronic device 500 of FIG. 5, and the electronic device 600 of FIG. 6) displaying an interface that displays a captured image 760 (e.g., the captured image 560 of FIG. 5 and the captured image 660 of FIG. 6) together with summary data 720 (e.g., the summary data 580 of FIG. 5 and the pieces of summary data 661, 681, 683, 687, and 687 of FIG. 6).

According to an embodiment, the interface illustrated in FIG. 7 may be an interface of a gallery application. For example, the captured image 760 may be displayed together with other images in the gallery application. In this case, the captured image 760 (e.g., the captured image 560 of FIG. 5 and the captured image 660 of FIG. 6) may be displayed in a thumbnail format. An indicator 770 (e.g., the indicator 570 of FIG. 5 and the indicator 670 of FIG. 6) indicating that the captured image 760 is stored together with the summary data 720 may be displayed.

Hereinafter, the display of the summary data 720 is described when the captured image 760 is displayed in a thumbnail format or when the captured image 760 is displayed on the entire display 710 (e.g., the display module 160 of FIG. 1, the display module 260 of FIG. 2, the display 510 of FIG. 5, and the display 610 of FIG. 6).

According to an embodiment, when the indicator 770 is selected, the summary data 720 may be displayed in a pop-up format. The summary data 720 may be data stored together with the captured image 760 by the first capture command or the second capture command described with reference to FIGS. 5 and 6. A button 730 may further be included at the lower end of the summary data 720. According to an embodiment, the button 730 may be a button that provides a summary of the entire video. That is, the summary of the entire video may be provided through the button 730, regardless of whether the summary data 720 is generated according to the first capture command or the second capture command. Here, among the summaries of the entire video, the summary data 720 may be displayed separately from other pieces of data. According to an embodiment, the button 730 may be a button that provides editing of the summary data 720. The section of the video in which the summary data 720 is generated may be changed through the button 730. For example, when the summary data 720 is data summarizing content included in a section from the beginning of the video to the playback position of the video corresponding to the time point at which a capture command is generated, the summary data 720 may be changed to data summarizing content included in a section from the playback position of the video corresponding to the time point at which the capture command is generated to the end of the video through the button 730.

According to an embodiment, when the captured image 760 is selected, the summary data 720 may be displayed in a pop-up format, and at the same time, the captured image 760 may be displayed on the entire display 710. The description of the summary data 720 and the button 730 is described above, so a repeated description thereof is omitted. According to an embodiment, the summary data 720 may be expanded and displayed on the display 710.

Hereinafter, a case in which a web page, other than a video, is captured is described.

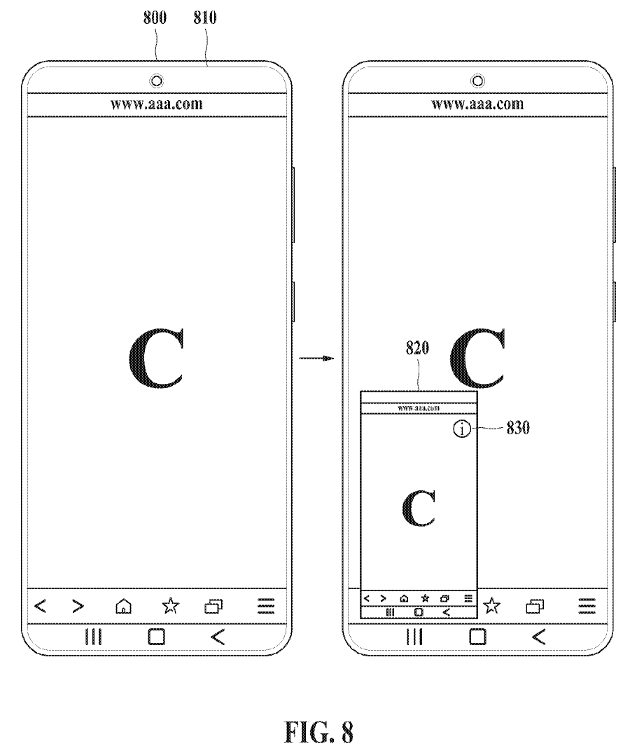

FIG. 8 is a diagram illustrating the generation of summary data of a web page, according to an example embodiment.

FIG. 8 illustrates an electronic device 800 (e.g., the electronic device 101 of FIG. 1, the electronic device 200 of FIG. 2, the electronic device 500 of FIG. 5, the electronic device 600 of FIG. 6, and the electronic device 700 of FIG. 7) outputting the web page.

When a capture command is generated while the web page is being output, the electronic device 800 may determine whether a display 810 (e.g., the display module 160 of FIG. 1, the display module 260 of FIG. 2, the display 510 of FIG. 5, the display 610 of FIG. 6, and the display 710 of FIG. 7) is outputting a video. When the display 810 is not outputting the video, the electronic device may determine whether the display 810 is outputting the web page.

When the display 810 is outputting the web page, the electronic device 800 may capture the web page and generate summary data summarizing content of the captured web page. Here, the summary data may be data summarized based on text. FIG. 8 illustrates a captured image 820 (e.g., the captured image 560 of FIG. 5, the captured image 660 of FIG. 6, and the captured image 760 of FIG. 7). Here, an indicator 830 (e.g., the indicator 570 of FIG. 5, the indicator 670 of FIG. 6, and the indicator 770 of FIG. 7) indicating that the summary data is generated together with the captured image 820 may be displayed.

Except that the summary data of the web page is based on text, it is obvious to those skilled in the art that the description provided with reference to FIGS. 5 to 7 may be equally applied even when the web page is captured.

FIG. 9 is a diagram illustrating an operating method of an electronic device, according to an example embodiment.

The operations described below may be performed sequentially but not necessarily. For example, the order of the operations may be changed, and at least two operations may be performed in parallel. The operations illustrated in FIG. 4 may be performed by at least one component of an electronic device (e.g., the electronic device 101 of FIG. 1, the electronic device 200 of FIG. 2, the electronic device 500 of FIG. 5, the electronic device 600 of FIG. 6, the electronic device 700 of FIG. 7, and the electronic device 800 of FIG. 8).

In operation 910, when a capture command is received from a user, the electronic device may determine whether a display (e.g., the display module 160 of FIG. 1, the display module 260 of FIG. 2, the display 510 of FIG. 5, the display 610 of FIG. 6, the display 710 of FIG. 7, and the display 810 of FIG. 8) of the electronic device is outputting a video.

In operation 920, when the display is outputting the video, the electronic device may generate summary data summarizing content of the video.

In operation 930, the electronic device may store a captured image (e.g., the captured image 560 of FIG. 5, the captured image 660 of FIG. 6, the captured image 760 of FIG. 7, and the captured image 820 of FIG. 8) obtained by capturing a screen being output by the display and summary data (e.g., the summary data 580 of FIG. 5, the pieces of summary data 661, 681, 683, 685, and 687 of FIG. 6, and the summary data 720 of FIG. 7) together in memory.

In operation 940, the electronic device may display the captured image and the summary data together on the display.

Since the description provided with reference to FIGS. 1 to 8 is equally applied to each operation provided with reference to FIG. 9, a detailed description thereof is omitted.

According to an embodiment, the captured image and the summary data may be displayed together on an interface displaying the captured image.

According to an embodiment, the summary data of the video may include data summarizing content included in the entire video, regardless of the time point at which the capture command is generated.

According to an embodiment, the summary data of the video may include data summarizing content included in a section from the beginning of the video to a playback position of the video corresponding to the time point at which the capture command is generated.

According to an embodiment, the summary data of the video may include data summarizing content included in a section from the playback position of the video corresponding to the time point at which the capture command is generated to the end of the video.

According to an embodiment, the summary data of the video may include data summarizing content included in a section controlled according to the operation of the user, based on the time point at which the capture command is generated.

According to an embodiment, the summary data of the video may include data summarizing content related to the captured image included in the video.

According to an embodiment, the summary data of the video may summarize content of the video based on the capture command.

According to an embodiment, the capture command may include a first capture command generated for a time that is less than a threshold time, according to the operation of the user. The capture command may include a second capture command generated for a time that is greater than or equal to the threshold time.

According to an embodiment, the summary data of the video may include data summarizing content related to the captured image or data summarizing content included in a section determined based on the time point at which the capture command is generated, depending on whether the capture command is the first capture command or the second capture command.

According to an embodiment, the instructions, when executed by a processor, may cause the electronic device to display the summary data and the captured image on the display before the captured image and the summary data are stored together in the memory. The instructions, when executed by the processor, may cause the electronic device to store the captured image and the summary data together in the memory or to modify the summary data, according to a command of the user.

An electronic device according to an example embodiment may include memory storing instructions. The electronic device may include a processor for executing the instructions. The instructions, when executed by the processor, may cause the electronic device to determine whether a display of the electronic device is outputting a video when the electronic device receives a capture command from a user. The instructions, when executed by the processor, may cause the electronic device to generate summary data summarizing content of the video when the display is outputting the video. The instructions, when executed by the processor, may cause the electronic device to store a captured image obtained by capturing a screen being output by the display and the summary data together in the memory. The summary data may summarize the content of the video based on the capture command.

An operating method of an electronic device according to an example embodiment may include determining whether a display of the electronic device is outputting a video when the electronic device receives a capture command from a user. The operating method of the electronic device may include generating summary data summarizing content of the video when the display is outputting the video. The operating method of the electronic device may include storing a captured image obtained by capturing a screen being output by the display and the summary data together in memory. The operating method of the electronic device may include displaying the captured image and the summary data together on the display.

According to an embodiment, the captured image and the summary data may be displayed together on an interface that displays the captured image.

According to an embodiment, the summary data of the video may include data summarizing content included in the entire video, regardless of the time point at which the capture command is generated.

According to an embodiment, the summary data of the video may include data summarizing content included in a section from the beginning of the video to the playback position of the video corresponding to the time point at which the capture command is generated.

According to an embodiment, the summary data of the video may include data summarizing content included in a section from the playback position of the video corresponding to the time point at which the capture command is generated to the end of the video.

According to an embodiment, the summary data of the video may include data summarizing content included in a section controlled according to the operation of the user, based on the time point at which the capture command is generated.

According to an embodiment, the summary data of the video may include data summarizing content related to the captured image included in the video.

According to an embodiment, the summary data of the video may summarize content of the video based on the capture command.

According to an embodiment, the capture command may include a first capture command generated for a time that is less than a threshold time, according to the operation of the user. The capture command may include a second capture command generated for a time that is greater than or equal to the threshold time. The summary data of the video may include data summarizing content related to the captured image or data summarizing content included in a section determined based on the time point at which the capture command is generated, depending on whether the capture command is the first capture command or the second capture command. “Based on” as used herein covers based at least on.

According to an example embodiment, a computer-readable storage medium storing a program for executing the operating method of the electronic device described above is disclosed.

The embodiments of the present disclosure disclosed in the specification and the drawings are merely presented to easily describe technical contents of various embodiments of the present disclosure and help the understanding of them and are not intended to limit the various embodiments. Therefore, all changes or modifications derived from the technical idea of the various embodiments of the present disclosure as well as the various embodiments disclosed herein should be construed to fall within the various embodiments.

1. An electronic device comprising:
memory storing instructions; and
a processor, comprising processing circuitry and one or more processors, for executing the instructions,
wherein the instructions, when executed by the processor, cause the electronic device to:
determine whether a display of the electronic device is outputting a video when the electronic device receives a capture command from a user,
generate summary data summarizing content of the video when the display is outputting the video, and
store a captured image obtained at least by capturing a screen being output by the display and the summary data in the memory.

2. The electronic device of claim 1, wherein the processor is configured so that the captured image and the summary data are displayed together on an interface that displays the captured image.

3. The electronic device of claim 1, wherein the summary data of the video comprises data summarizing content comprised in the entire video, regardless of a time point at which the capture command is generated.

4. The electronic device of claim 1, wherein the summary data of the video comprises data summarizing content comprised in a section from a beginning of the video to a playback position of the video corresponding to a time point at which the capture command is generated.

5. The electronic device of claim 1, wherein the summary data of the video comprises data summarizing content comprised in a section from a playback position of the video corresponding to a time point at which the capture command is generated to an end of the video.

6. The electronic device of claim 1, wherein the summary data of the video comprises data summarizing content comprised in a section controlled based on an operation of the user, based on a time point at which the capture command is generated.

7. The electronic device of claim 1, wherein the summary data of the video comprises data summarizing content related to the captured image comprised in the video.

8. The electronic device of claim 1, wherein the summary data of the video summarizes the content of the video based on the capture command.

9. The electronic device of claim 1, wherein the capture command comprises a first capture command generated for a time that is less than a threshold time and a second capture command generated for a time that is greater than or equal to the threshold time, based on an operation of the user.

10. The electronic device of claim 1, wherein the summary data of the video comprises data summarizing content related to the captured image and/or data summarizing content comprised in a section determined based on a time point at which the capture command is generated, depending on whether the capture command is the first capture command or the second capture command.

11. The electronic device of claim 1, wherein the instructions, when executed by the processor, cause the electronic device to:
display the summary data and the captured image on the display before the captured image and the summary data are stored together in the memory, and according to a command of the user, store the captured image and the summary data together in the memory and/or modify the summary data.

12. An electronic device comprising:
memory storing instructions; and
a processor, comprising processing circuitry and one or more processors, for executing the instructions,
wherein the instructions, when executed by the processor, cause the electronic device to:
determine whether a display of the electronic device is outputting a video when the electronic device receives a capture command from a user,
generate summary data summarizing content of the video when the display is outputting the video, and
store a captured image obtained at least by capturing a screen being output by the display and the summary data in the memory, and
wherein the summary data summarizes the content of the video based on the capture command.

13. An operating method of an electronic device, the method comprising:
determining whether a display of the electronic device is outputting a video when the electronic device receives a capture command from a user;
generating summary data summarizing content of the video when the display is outputting the video; and
storing a captured image obtained by capturing a screen being output by the display and the summary data together in memory.

14. The operating method of claim 13, wherein the captured image and the summary data are displayed together on an interface that displays the captured image.

15. The operating method of claim 13, wherein the summary data of the video comprises data summarizing content comprised in the entire video, regardless of a time point at which the capture command is generated.

16. The operating method of claim 13, wherein the summary data of the video comprises data summarizing content comprised in a section from a beginning of the video to a playback position of the video corresponding to a time point at which the capture command is generated.

17. The operating method of claim 13, wherein the summary data of the video comprises data summarizing content comprised in a section from a playback position of the video corresponding to a time point at which the capture command is generated to an end of the video.

18. The operating method of claim 13, wherein the summary data of the video comprises data summarizing content comprised in a section controlled based on an operation of the user, based on a time point at which the capture command is generated.

19. The operating method of claim 13, wherein the summary data of the video comprises data summarizing content related to the captured image comprised in the video.

20. The operating method of claim 13, wherein the capture command comprises a first capture command generated for a time that is less than
a threshold time and a second capture command generated for a time that is greater than or equal to the threshold time, based on an operation of the user.
